(19) United States
(12) Patent Application Publication
(10) Pub. No.: US 2017/0320765 A1
(43) Pub. Date: Nov. 9, 2017

(54) Water Reuse System

(71) Applicant: Bigelow Aerospace, North Las Vegas, NV (US)

(72) Inventors: Robert T. Bigelow, Henderson, NV (US); Sherwin Gromly, Las Vegas, NV (US); Colm Kelleher, Henderson, NV (US); Robert Hale, Las Vegas, NV (US); Keith Cooker, Las Vegas, NV (US)

(73) Assignee: Bigelow Development Aerospace

(21) Appl. No.: 14/999,442

(22) Filed: May 5, 2016

(51) Int. Cl. C02F 9/00; C02F 1/44; C02F 1/28; C02F 1/32; C02F 1/467; C02F 101/32; C02F 101/16

(52) U.S. Cl. CPC C02F 9/00; C02F 1/32; C02F 1/441; C02F 1/4674; C02F 1/283; C02F 2101/16; C02F 2201/001; C02F 2209/05; C02F 2209/06; C02F 2303/04; C02F 2101/32

(57) ABSTRACT

A water reuse system is disclosed. The system can be directed to space or terrestrial applications. The system combines electro-oxidation, granulated activated carbon, and reverse osmosis techniques in a manner that requires lower power and less use of chemicals for water purification than existing space recycle/reuse systems

### FIELD OF THE INVENTION

This invention generally relates to recycling water. While primarily focused on applications in space, the invention can also extend to terrestrial applications.

### BACKGROUND OF THE INVENTION

Human space flight makes unique demands on resource recycle and habitat environmental control design. An important part of this design is the recycling and recapture of water. Recycling wastewater aboard a spacecraft reduces the need for resupply, which in turn impacts the cost of operating a human rated spacecraft. However, wastewater generated in a spacecraft has specific characteristics that can make recycling challenging.

Water recycle/reuse design for Environmental Control and Life Support Systems (ECLSS) requires architecture that is highly specific to urine/urea dominated waste streams to address. While biological treatment using, for example, an aerobic activated sludge process has traditionally been employed in many terrestrial situations, the urine/urea dominated case in space applications, that is also found in some agricultural, advanced sustainable buildings and industrial waste streams, will have an imbalanced carbon to nitrogen ratio, and thus poor candidates for normal biological wastewater treatment.

For applications in space it is also important that a water recycle/reuse system consume as little power as possible. While nuclear reactors may be applied to space applications, the units tend to be heavy and therefore costly to launch into space and present safety issues due to the radioactive core. It would be desirable to have a recycle/reuse system that could operate on lower power as provided, for example, by solar cell arrays.

Another aspect of a water recycle/reuse system deployed in space is complexity. The International Space Station (ISS) relied upon both physical and chemical processes to remove contaminants, as well as filtration, phase change, and temperature sterilization to ensure the water was safe to drink. These systems typically employ moving parts such as centrifuges and chemicals for water treatment.

It would be desirable to have a water recycle/reuse system with less moving parts, required less power to operate, and required less chemical treatment in the process.

### SUMMARY OF THE INVENTION

A method of water recycle/reuse is disclosed. Wastewater that contains an amount of urea is directed to an electro-oxidation loop. There is a monitor that is positioned at a point in the loop before the wastewater enters an electro-oxidation unit and the monitor detects the pH and utilizes the pH value to estimate free available Chlorine in the wastewater. The wastewater goes through the electro-oxidation unit and an amount of total organic carbon from the wastewater is converted. The wastewater cycles through the loop and the electro-oxidation unit until a desired level of total organic carbon is removed. In one embodiment the level removed could be in excess of 80% and another embodiment the level removed could be approximately 95% of the total carbon in the wastewater. In both cases, total organic carbon is converted to CO2, N2, and H2 while simultaneously generating a chlorine residual that stabilizes and disinfects an interim brine by tracking a drop to a pH below 3.5, with the typical control cutoff point site to a pH below 2.5 (+/−0.75).

The treated wastewater then goes to a secondary reverse osmosis treatment loop to remove impurities from the wastewater by passing the wastewater through a reverse osmosis element. From there, in one embodiment the wastewater that has been further purified by the reverse osmosis element goes through a granular activated carbon filter to further remove impurities from the wastewater.

Next, the wastewater goes through an ultra-violet element to sterilize the water and protects the RO and GAC from back contamination between treatment runs. In one embodiment at this point minerals are added to the water and the water can be used as drinking water.

### BRIEF DESCRIPTION OF THE DRAWINGS

The invention is generally shown by way of reference to the accompanying drawings in which:

FIG. 1 is a schematic of an embodiment of the water reuse system of the present invention.

FIG. 2 is a chart identifying the chlorination breakpoint.

### DETAILED DESCRIPTION OF THE INVENTION

The Water Reuse System has a process architecture that is calibrated and optimized to address urine by a combination of Electro-Oxidation (EO), Granular Activated Carbon (GAC), and Reverse Osmosis (RO) with gas removal while producing high quality water and brine. It is initially targeted to include, but not limited to, microgravity applications.

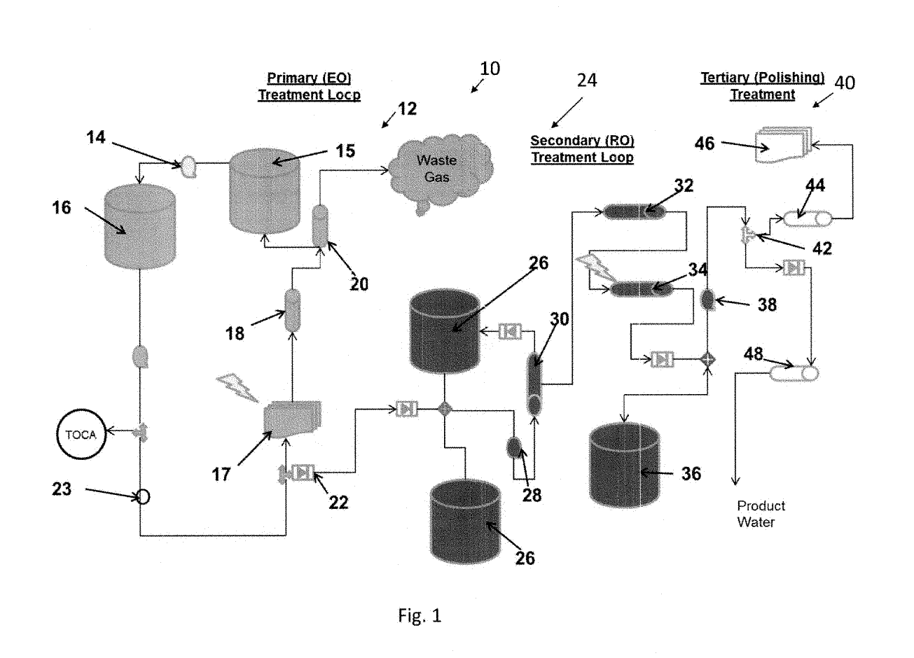

Turning to FIG. 1, the water recycle/reuse system (10) includes a Primary (EO) Treatment Loop (12). There are pumps (14) that circulate the wastewater through the system. The wastewater is held in recirculating capacitance tank (15) and primary process batch tank (16). The wastewater travels through the electro-oxidation unit (17) to a cross flow heat exchanger (18) and on to a primary de-gas (20) unit that extracts the waste gas and on toward the recirculating capacitance tank (15). The heat exchanger (18) can be chosen to operate to maintain EO loop temperature control. This can be accomplished by several means including calibrating and optimizing system elements to one another based upon calculated operational parameters or historical statistical data. The wastewater can go through a number of cycles to obtain the desired level or purity. When the water is ready to proceed to the next phase it is passed through a valve (22).

EO is employed to remove approximately 95% of the Total Organic Carbon (TOC) by converting it directly to CO2, N2, and H2, while simultaneously generating a chlorine residual that stabilizes and disinfects the interim brine (water with a measurable salinity for the urine remaining). This low TOC stable brine is achieved by operation of EO technology within the primary (first) wastewater treatment loop. The placement of the EO in the EO-GAC-RO system is synergistic in that it takes advantage of the high salt content of urine to “amp up” the EO performance in destroying the high Nitrogen containing the compound Urea. In other non-urine applications it is actually necessary to add salt to the EO mix to achieve the high level of oxidation performance. It is the placement of the EO at the beginning of the Liquid Processing Cycle that makes the difference by utilizing the high salt levels of urine to drive EO performance. The EO includes the use of various forms of Electro-oxidation water treatment cells (electrode configurations) that can be applied depending upon the application such as space, extraterrestrial masses, or terrestrial uses. The cell in this process can be energy efficient as compared to other purification processes.

The International Space Station (“ISS”—the only operational water recovery system in space), uses distillation as the primary method of separating salt and some organics; however because of the latent heat of vaporization involved in phase changes, by definition this necessitates a high power (Whr/Kg) operation costs. The EO-GAC-RO avoids the phase change problem and is thus more amenable to power saving strategies.

Because closed habitat water is typically a combination of human urine and condensate recovered from the spacecraft air handing system in roughly equal portions, the urea provides a unique chemical signal that indicates when optimal EO treatment time is achieved. This process control is provided by tracking a drop to a pH below 3.5, with the typical control cutoff point site to a pH of 2.5 (+/−0.75). This pH drop is an artifact of the overproduction of free available chlorine (and thus HCl) at the point in the process that the majority of urea (the primary TOC component of urine) is destroyed, indicating that the EO has completed the organic destruction in the primary loop to a satisfactory degree.

This control parameter occurs because the complex organics tend to be destroyed first in urine, as they require much less energy to cleave than urea. As upwards of 40% to 50% of the TOC in urine (and thus spacecraft and other urine dominated wastewater) is urea, the vast majority of the other organics are destroyed before the urea is removed appreciably. Once the urea destruction commences urea is cleaved to ammonium (a basic substance) and thus the pH remains flat or slightly elevated until the urea is mostly removed, and then starts dropping rapidly as hydrochloric acid builds and ammonium ions disappear. This provides a convenient, unique and valuable end point signal for urine based wastewater treatment for organics (a rare, unusual, and valuable signal in wastewater treatment).

Once the wastewater is treated to this clean stable brine intermediate the brine is accumulated and stored for any desired length of time prior to being passed through an RO membrane system (RO loop). The RO loop system is roughly calibrated to reject up to 1.5× the salinity of seawater (as measured by an electro-conductivity sensor), and is thus constructed from widely available seawater desalination technology. GAC filtration can be located before the RO to protect it from the oxidants remaining in the EO treated waters, or after the RO as a pure polishing step if pre-filtration is not required, or both as necessary to achieve optimal water aesthetics (i.e. taste and odor properties referred to in drinking water law as aesthetics).

The fundamental requirement of the RO loop is to remove inorganic ions (salts) and is under the control of a simple electro-conductivity probe on the reject side of the RO system. As this is a common control parameter for RO performance, electro-conductivity is not as unique an aspect of the system as pH control of TOC treatment cutoff in the primary loop, but is none the less essential for full system architecture performance.

The ISS currently uses Sulfuric Acid Chromic Acid as a biocide to pre-treat urine prior to Distillation in the UPA/WPA system. This Sulfuric Acid/Chromic acid combination is highly toxic, corrosive and produces an extremely corrosive brine. One attribute of the EO system disclosed is that the system creates high levels of Mixed Oxidants and produces its own biocide without the necessity of pretreatment.

Taken as a cohesive treatment train the EO/GAC/RO ECLSS Water Reuse System (with its unique calibrating pH system control logic) is specifically targeted as a new and sufficiently innovative way to provide a substantial advancement of the water treatment art for advanced water reuse, particularly but not limited to Environmental Control and Life Support Systems (ECLSS) for spacecraft. It should be noted that this synergy and control mechanism is not readily apparent by examining the processes separately using the normal wastewater treatment composition based chemistry and process logic that usually dictates the use of the individuals processes (EO/GAC/RO) applied. This combination is specifically tailored to convert urine/urea dominated wastewater to drinking water for closed habitats (and other urea dominated zero discharge applications).

An aspect of the controls logic involves the low pH as an easily detectable threshold signal for the end point of the EO process that does not require complex sensor arrays and also saves system power. Other attributes are that the primary loop generates its own biocide in situ and therefore (a) is self-cleaning and (b) eliminates the need of adding toxic, expensive biocides to the water treatment system to combat bacterial growth. A second aspect is the salinity balance that allows the use of seawater desalination calibrated RO to achieve 90%+ water recovery from urine, after EO has destroyed the RO incompatible components of urine. The choice of a membrane element can include any and all available forms of reverse osmosis seawater range membrane desalination systems, membrane elements that can be chosen depending upon the application such as space, extra-terrestrial mass, or terrestrial application.

The sampling point (23) is the location of a point in the system to sample pH and thus estimate available Chlorine. In FIG. 1, the location (23) is preferred in the embodiment disclosed. However, other architectures could have other locations for the sampling.

In the Secondary (RO) Treatment Loop (24) the water is stored in brine loop tanks (26). After an indefinite hold time the interim water is delivered to an RO/GAC combined secondary step (the secondary and/or RO loop) which removes the inorganic (salts) portion of the contaminants from the urine based EU product brine. A pump (28) circulates the water and the water passes through a reverse osmosis (RO) element (30). Water is directed to, or from, the RO Element (30) to the GAC (32) for further purification and then to an ultraviolet element (34) that performs disinfection. A variety of forms of activated carbon and/or absorbent water treatment elements can be used as required by the specific application and may be arranged differently, without affecting the basic EO/RO system function.

GAC provides final trimming of the TOC contaminant level in order to meet drinking water standards, as well as de-chlorinating the EO product brine prior to the RO membrane. The water can be stored in a Primary Long Term Drinking Water Tank (36). A pump (38) can direct the water to the final stage or Tertiary (Polishing) Treatment (40). After an indefinite hold time the interim water is delivered to an RO/GAC combined secondary step (the secondary and/or RO loop) which removes the inorganic (salts) portion of the contaminants from the urine based EO product brine. RO/GAC loop control is provide by an Electro-conductivity (EC) Sensor driving water cutoff to the optimal salt rejection for the RO membrane used.

In the Tertiary Polishing Treatment (40) the water can be directed by a valve (42) to an ion exchange (44) and from there to O2 generation (46). The other path is to further disinfect and add minerals (48) to the water and then the water is ready for use in the spacecraft or other environment. Still, in other embodiments, additional ion adsorption of GAC can be incorporated to produce ultrapure water for oxygen generation from drinking water produced by the primary system.

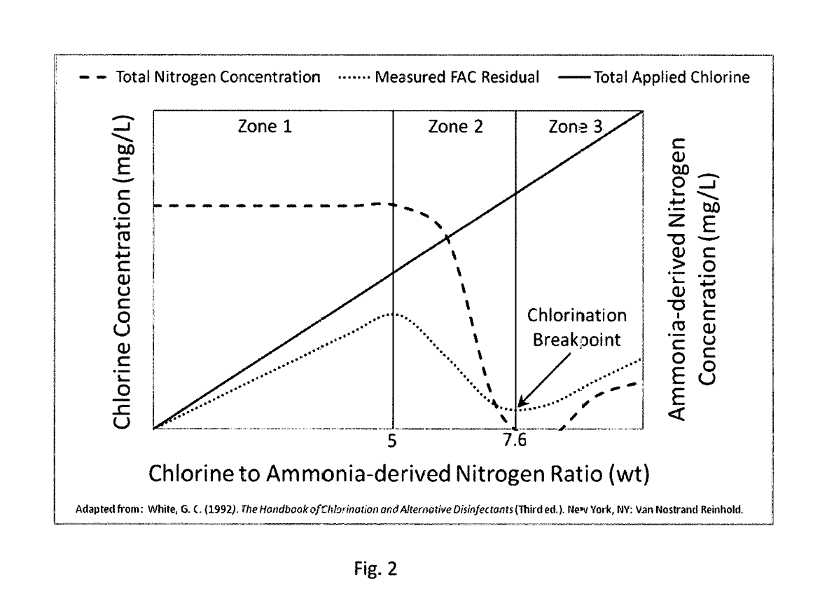

Returning to the Primary (EO) Treatment Loop, the pH signal for EO cut off is based on the dip seen in common break point chlorination of drinking water (FIG. 2). This is particularly pronounced and useful as a control parameter in our urea, and thus ammonia nitrogen dominated treatment 1st step. The breakpoint provides a discrete and clear signal as indicated in the figure due to the level of urea. Also, the rate of change of the total nitrogen concentration as shown in the FIG. 2 can be dramatic. This rate of change can be modified to comply with system requirements and to meet efficiency needs. A variety of microgravity compatible gas removal units that can include either membrane based or centripetal units can be used in the system depending upon the application. Furthermore, in other embodiments, Ultraviolet (UV) light based disinfection elements can be placed at other locations in the system such as at the rear (outlet end of the system) to prevent backward contamination of the RO loop.

Furthermore, chemical addition to an embodiment of the invention to enhance, or focus, performance in an application would be possible, but such would not depart from the scope of the present invention. This can extend to the use of pH and chemical adjustment for control, and the use of Electroconductivity measurements for control. Also, there could be use of Sodium Metabisulfite (SMBS) for pre-membrane contamination and the use of Oxidation Reduction (Redox) Potential measurements or ultraviolet for control.

As embodiments are directed to closed habitat and/or zero discharge applications due to this urine/urea dominated load, the scope is not departed by particular uses of EO, EO/RO, and EO/RO/GAC couples. The said use specifically includes, but is not limited to, the use of EO product brine, before and after concentration by clean water portion harvest by the reverse osmosis system, for use in long term stable storage and radiation shielding application within the habitat.

The use of any and all available (3rd) forms of Electro-oxidation water treatment cell (electrode configuration) regardless of the 3rd party art of that EO unit may also change due to application and requirement without departing from the scope of the invention. This extends to the use of any and all available (3rd) forms of reverse osmosis seawater range membrane desalination systems, membrane elements and pumps regardless of the 3rd party art of that RO unit. Furthermore, as to the use of any and all available (3rd) forms of all forms of activated carbon and/or absorbent water treatment elements regardless of the 3rd party art of these absorbents or adsorbent column.

The invention can include the use of any and all available (3rd) forms of microgravity compatible gas removal units to include either membrane based or centripetal units. Embodiments can also rely upon the use of necessary heat exchanger to maintain EO loop temperature control. It is also within the scope of the invention for the use of Ultraviolet (UV) light based disinfection element at the rear (outlet end of the system) to prevent backward contamination of the RO loop. Also included is the use of additional ion adsorption of GAC to produce ultrapure water for oxygen generation from drinking water produced by the primary system claimed system.

While embodiments have been described in detail, it should be appreciated that various modifications and/or variations may be made without departing from the scope or spirit of the invention. In this regard it is important to note that practicing the invention is not limited to the applications described herein. Many other applications and/or alterations may be utilized provided that such other applications and/or alterations do not depart from the intended purpose of the invention. Also, features illustrated or described as part of one embodiment may be used in another embodiment to provide yet another embodiment such that the features are not limited to the embodiments described herein. Nothing in this disclosure is intended to limit the scope of the invention in any way.

What is claimed is:

1. A method of water recycle/reuse comprising the steps of:
a) directing wastewater having a percentage of total organic carbon that includes urea to an electro-oxidation loop;
b) monitoring the pH as an indicator of the free available Chlorine in the wastewater at a point in the electro-oxidation loop before the wastewater enters an electro-oxidation unit;
c) directing the wastewater through the electro-oxidation unit to remove an amount of total organic carbon from the wastewater;
d) repeating steps b) and c) until approximately 95% of the total organic carbon initially in the wastewater is converted to CO2, N2, and H2 while simultaneously generating a chlorine residual that stabilizes and disinfects an interim brine by tracking a drop to a pH below 3.5, with the typical control cutoff point at or below a pH of 2.5 (+/−0.75);
e) directing the wastewater after approximately 95% of the initial total organic carbon has been converted to a secondary reverse osmosis treatment loop to remove impurities from the wastewater by passing the wastewater through a reverse osmosis element;
f) directing the wastewater that has been further purified by the reverse osmosis element through a granular activated carbon filter to further remove impurities from the wastewater;
g) directing the wastewater that has been further purified by the granular activated carbon filter through an ultra-violet element to further purify the water;
h) adding minerals to the water that has been further purified by the ultra-violet element; and
i) providing the water containing the minerals from step h) as drinking water.

2. The method of water recycle/reuse of claim 1 further comprising the step of utilizing an electro-conductivity sensor in connection with the reverse osmosis element and granulate activated charcoal filter to set water cutoff to the optimal salt rejection for a reverse osmosis membrane in the reverse osmosis element.

3. A method of water recycle/reuse comprising the steps of:
a) directing wastewater having a percentage of total organic carbon that includes a percentage of urea to an electro-oxidation loop;
b) monitoring the pH as an indicator of the free available Chlorine in the wastewater at a point in the electro-oxidation loop before the wastewater enters an electro-oxidation unit;
c) directing the wastewater through the electro-oxidation unit to remove an amount of total organic carbon from the wastewater;
d) repeating steps b) and c) until more than 80% of the total organic carbon initially in the wastewater is converted to CO2, N2, and H2 while simultaneously generating a chlorine residual that stabilizes and disinfects an interim brine by tracking a drop to a pH below 3.5, with the typical control cutoff point at or below a pH of 2.5 (+/−0.75),
e) directing the wastewater that has been further purified by the reverse osmosis element through a granular activated charcoal filter to further remove impurities from the wastewater;
f) directing the wastewater after more than 80% of the initial total organic carbon has been converted to a secondary reverse osmosis treatment loop to remove impurities from the wastewater by passing the wastewater through a reverse osmosis element;
g) directing the wastewater that has been further purified by the granular carbon filter through an ultra-violet element to further purify the water;
h) adding minerals to the water that has been further purified by the ultra-violet clement; and
i) providing the water containing the minerals from step h) as drinking water.

4. The method of water recycle/reuse of claim 3 further comprising the step of utilizing an electro-conductivity sensor in connection with the reverse osmosis element and granular activated carbon filter to set water cutoff to the optimal salt rejection for a reverse osmosis membrane in the reverse osmosis element.
